(19) United States
(12) Patent Application Publication
(10) Pub. No.: US 2013/0044899 A1
(43) Pub. Date: Feb. 21, 2013

(54) Dual Backplate Microphone

(71) Applicants: Joshua R. Barber, New Castle, IN (US); John Charles Baumhauer, JR., Indianapolis, IN (US); Jeffrey Phillip McAteer, Carmel, IN (US); Alan Dean Michel, Fishers, IN (US); James V. Olson, Indianapolis, IN (US)

(72) Inventors: Joshua R. Barber, New Castle, IN (US); John Charles Baumhauer, JR., Indianapolis, IN (US); Jeffrey Phillip McAteer, Carmel, IN (US); Alan Dean Michel, Fishers, IN (US); James V. Olson, Indianapolis, IN (US)

(73) Assignee: HARMAN INTERNATIONAL INDUSTRIES, INC., Stamford, CT (US)

(21) Appl. No.: 13/471,125

(22) Filed: May 14, 2012

Related U.S. Application Data
(60) Provisional application No. 61/523,426, filed on Aug. 15, 2011.

(51) Int. Cl. H04R 19/04; H04R 19/01; H04R 3/00

(52) U.S. Cl. 381/113; 381/111

(57) ABSTRACT

A dual backplate microphone is provided that utilizes either an electret condenser or a MEMS condenser configuration and in which an op-amp IC is electrically connected to both backplates and the conductive layer of the diaphragm.

### CROSS-REFERENCE TO RELATED APPLICATION

This application claims the benefit of the filing date of U.S. Provisional Patent Application Ser. No. 61/523,426, filed 15 Aug. 2011, the disclosure of which is incorporated herein by reference for any and all purposes.

### FIELD OF THE INVENTION

The present invention relates generally to microphones and, more particularly, to a dual backplate microphone.

### BACKGROUND OF THE INVENTION

There is a great need to continually improve the signal-to-electrical noise ratio (SNR) of audio microphones such as electret condenser microphones (ECM), MEMS condenser microphones, and MEMS with electret biasing microphones. The electrical noise in variable capacitive microphones of this type is largely determined by the amplifier integrated circuit (IC) contained within the microphone case or package. As such, it is critical to optimize the audio signal level arriving at the input of the IC from the microphone's acoustic-to-electrical capacitive transduction cell, the cell being comprised essentially of the movable diaphragm with electrode, air gap, and fixed or so called “backplate” electrode. Audio signal level optimization is usually achieved by increasing the cell's open circuit audio signal voltage amplitude (E_{oc}), increasing the cell's active, i.e., signal varying, capacitance (Cₐ), and/or decreasing its fixed stray capacitance (Cₛ), preferably without increasing the overall size of the cell. Parameters that may be optimized include the diaphragm's tension or plate-type mechanical stiffness, the air gap height, the implanted electret charge and its equivalent voltage level, and/or the external polarizing voltage for MEMS type microphones.

Dual backplate microphones, also referred to as push-pull microphones, utilize a diaphragm located between two backplates. Each of the two backplates include one or more acoustic apertures that allow acoustic pressure to pass through the backplates and deflect the diaphragm. Unfortunately, both structural and electrical interconnection difficulties have prevented significant high production volume commercial applications of this type of microphone. The present invention overcomes these difficulties.

### SUMMARY OF THE INVENTION

The present invention provides an electret condenser microphone (ECM) that fits within an electrically conductive casing and that includes first and second backplates with a diaphragm interposed between the two backplates, and with a first electret layer interposed between the first backplate and an electrically conductive layer of the diaphragm and a second electret layer interposed between the second backplate and the electrically conductive layer of the diaphragm. The electret layers may be attached to either the backplates or to the diaphragm. A circuit board closes the opening of the casing. The lower backplate of the two backplates, i.e., the backplate closest to the circuit board, fits within an electrically non-conductive tensioning ring (e.g., a ceramic tensioning ring). The tensioning ring preferably includes metallized surfaces/pathways that are used to electrically connect the conductive layer of the diaphragm to the IC via the circuit board. Spacers are used to create air gaps between each backplate and the diaphragm. An op-amp IC is electrically coupled to both backplates and the diaphragm, the op-amp IC providing signal processing for the ECM. The ECM preferably includes an electrically conductive spring washer interposed between the circuit board and the lower backplate.

In at least one configuration, the op-amp IC is a voltage-type IC in which the first IC input is electrically connected to the second backplate via the circuit board and the spring washer, and in which the second IC input is electrically connected to the first backplate via the circuit board and the electrically conductive casing. Preferably the second IC input is electrically connected to an electrically conductive layer of the diaphragm via the circuit board and a plurality of metallized surfaces/pathways on the tensioning ring. In at least one embodiment, the diaphragm is comprised of a polymeric base film resin bulk alloyed with a conductive additive, where the diaphragm has a surface resistivity of between 5.0E10 and 1.0E13 ohms/square, and more preferably between 1.0E11 and 5.0E11 ohms/square. In at least one other embodiment, the diaphragm is comprised of a non-conductive base film and a surface metallization, where the diaphragm has a surface resistivity of between 5.0E10 and 1.0E13 ohms/square, and more preferably between 1.0E11 and 5.0E11 ohms/square.

In at least one other configuration, the op-amp IC is a differential IC in which the first IC input is electrically connected to the second backplate via the circuit board and the spring washer, and in which the second IC input is electrically connected to the first backplate via the circuit board and the electrically conductive casing, and in which a reference IC input is electrically connected to an electrically conductive layer of the diaphragm via the circuit board and a plurality of metallized surfaces/pathways on the tensioning ring.

In at least one other configuration, the op-amp IC is a charge-type IC in which the first IC input is electrically connected to the diaphragm via the circuit board and a plurality of metallized surfaces/pathways on the tensioning ring, and in which the second IC input is electrically connected to the first backplate via the circuit board and the electrically conductive casing and to the second backplate via the circuit board and the spring washer.

In another aspect of the invention, a MEMS type microphone is provided that includes a first micromachined backplate comprised of at least one layer of conductive material and at least one acoustic aperture, a second micromachined backplate comprised of at least one layer of conductive material and at least one acoustic aperture, a diaphragm that includes at least one electrically conductive layer and that is interposed between the first and second micromachined backplates, a first spacer separating the first micromachined backplate from the diaphragm and creating a first air gap, a second spacer separating the second micromachined backplate from the diaphragm and creating a second air gap, and an op-amp IC that is electrically coupled to both micromachined backplates and to the diaphragm, the op-amp IC providing signal processing for the MEMS type microphone.

In at least one configuration, a charge pump is coupled to the diaphragm and the op-amp IC is a voltage-type IC in which the first IC input is electrically connected to the first micromachined backplate, and in which the second IC input is electrically connected to the second micromachined backplate, and in which the first IC input is electrically connected to an electrically conductive layer of the diaphragm via the charge pump. A source of resistance, such as the diaphragm having a surface resistivity of between 5.0E10 and 1.0E13 ohms/square, may be placed in series with the charge pump.

In at least one configuration, a charge pump is coupled to the diaphragm and the op-amp IC is a differential op-amp IC in which the first IC input is electrically connected to the first micromachined backplate, and in which the second IC input is electrically connected to the second micromachined backplate, and in which a reference input of the differential op-amp IC is electrically connected to an electrically conductive layer of the diaphragm via the charge pump.

In at least one configuration, the op-amp IC is a charge-type op-amp IC and the first IC input is electrically connected to an electrically conductive layer of the diaphragm, and in which a second IC input is electrically connected to the first micromachined backplate via a first charge pump and electrically connected to the second micromachined backplate via a second charge pump.

A further understanding of the nature and advantages of the present invention may be realized by reference to the remaining portions of the specification and the drawings.

### BRIEF DESCRIPTION OF THE DRAWINGS

FIG. 1 illustrates the basic elements of a conventional electret microphone;

FIG. 2 provides a cross-sectional view of a preferred embodiment of an ECM in accordance with the invention;

FIG. 3 provides a detailed cross-sectional view of a portion of the ECM shown in FIG. 2;

FIG. 4 illustrates a preferred configuration for coupling a voltage-type amplifier IC to the ECM shown in FIGS. 2 and 3;

FIG. 5 illustrates an alternate preferred configuration for coupling a differential voltage-type amplifier IC to the ECM shown in FIGS. 2 and 3;

FIG. 6 provides a perspective view of a spring washer for use in the ECM shown in FIGS. 2 and 3;

FIG. 7 provides a perspective view of an alternate spring washer for use in the ECM shown in FIGS. 2 and 3;

FIG. 8 provides a cross-sectional view of an alternate preferred embodiment of an ECM;

FIG. 9 provides a detailed cross-sectional view of a portion of the ECM shown in FIG. 8;

FIG. 10 illustrates a preferred configuration for coupling a charge-type amplifier IC to the ECM shown in FIGS. 8 and 9;

FIG. 11 illustrates an alternate electret configuration for use with the embodiments shown in FIGS. 2 and 8;

FIG. 12 illustrates another alternate electret configuration for use with the embodiments shown in FIGS. 2 and 8;

FIG. 13 illustrates yet another alternate electret configuration for use with the embodiments shown in FIGS. 2 and 8;

FIG. 14 illustrates an ECM similar to the ECM shown in FIG. 2, except that the electret charged fluoropolymer layer is applied directly to the inner surface of the upper ferrule surface;

FIG. 15 provides a detailed cross-sectional view of a portion of the ECM shown in FIG. 14;

FIG. 16 illustrates a gradient type ECM based on the configuration shown in FIG. 2;

FIG. 17 illustrates a gradient type ECM based on the configuration shown in FIG. 8;

FIG. 18 illustrates a preferred embodiment of a MEMS type microphone coupled to a voltage-type amplifier IC in accordance with the invention;

FIG. 19 illustrates a preferred embodiment of a MEMS type microphone coupled to a differential voltage-type amplifier IC in accordance with the invention; and

FIG. 20 illustrates a preferred embodiment of a MEMS type microphone coupled to a charge-type amplifier IC in accordance with the invention.

### DESCRIPTION OF THE SPECIFIC EMBODIMENTS

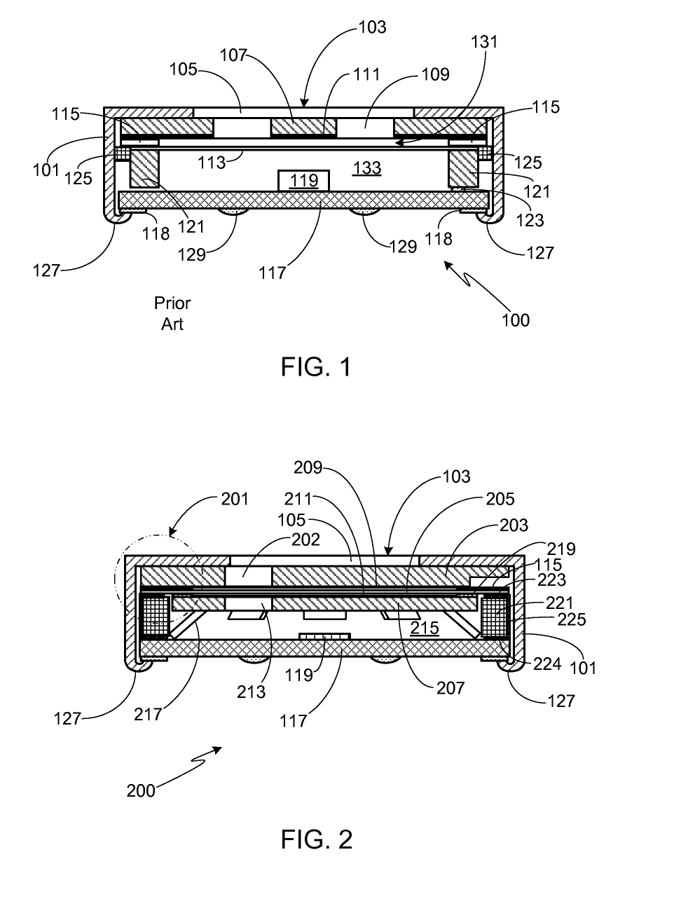

FIG. 1 illustrates the basic elements of a conventional electret microphone, often referred to as a single-sided electret microphone. As shown in this cross-section, microphone 100 includes an electrically conductive, cylindrical casing 101, also referred to as a ferrule. In a typical microphone, ferrule 101 has a diameter of between 3 and 10 millimeters. The front face 103 of an end portion of casing 101 includes one or more, substantially co-located, acoustic apertures 105. An electrode plate 107 with one or more secondary acoustic apertures 109 fits against the inner surface of front portion 103 of casing 101. An electret material 111 is deposited on, or otherwise applied to, the inner surface of electrode 107 and charged. A metallized polymer diaphragm 113 is separated from electret material layer 111 by an electrically insulating spacer 115.

A printed circuit board (PCB) 117 fits within, and covers, the casing opening located at the distal end opposite front face 103. An integrated circuit (IC) 119, or one or more signal processing elements (e.g., a field effect transistor or FET), are attached to PCB 117 and contained within casing 101 as shown. Electrode patterns on PCB 117, represented by raised contact regions 118, are used in conjunction with electrically conductive casing 101 to couple signal processing IC 119 to electrode plate 107. Metallized diaphragm 113 is coupled to signal processing IC 119 via an electrically conductive spacer 121 and a raised contact region 123 located on the bottom surface of PCB 117. Spacer 121 is typically ring-shaped. An electrically insulating spacer 125, also typically ring-shaped, is used to prevent shorting of spacer 121 to casing 101 as well as insuring that spacer 121 is properly positioned relative to contact region 123. End edge portion 127 of casing 101 is folded over and crimped, thereby compressing circuit board 117, spacer 121, and metallized diaphragm 113 against each other and holding the individual components in place. Solder bumps 129 are used to electrically couple the microphone element to the intended device (i.e., cell phone, camcorder, etc.).

As known by those of skill in the art, there are numerous possible configurations for a conventional electret condenser microphone (ECM) element. The microphone element described above relative to FIG. 1 is but one such configuration, generally referred to as an inverted back-electret arrangement. Another exemplary prior art arrangement, referred to as a back-electret arrangement, reverses the positions of elements 107, 111, 115, and 113, placing electrode plate 107 toward the back of the structure. In such a configuration, electrode 107 is usually called the backplate. In yet another exemplary prior art arrangement, referred to as a foil-electret arrangement, the electret material layer is deposited on the diaphragm and charged instead of being placed on the backplate electrode. In both alternate configurations briefly described above, other changes to the structure are necessary.

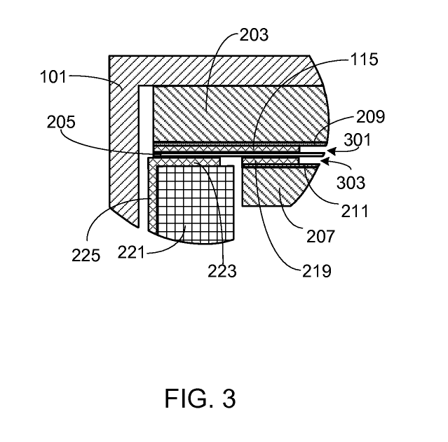

FIG. 2 provides a cross-sectional view of a preferred embodiment of an ECM 200 in accordance with the invention. FIG. 3 provides a detailed cross-sectional view of portion 201 of ECM 200. Sound enters acoustic aperture(s) 105 located in the front face 103 of the end portion of casing 101, and then passes through one or more secondary acoustic apertures 202 located in the fixed metallic upper backplate 203. Diaphragm 205 is positioned between upper backplate 203 and fixed metallic lower backplate 207, wherein upper backplate 203 includes an electret charged fluoropolymer layer 209 and lower backplate 207 includes an electret charged fluoropolymer layer 211. As shown in the detailed view of FIG. 3, an upper air gap 301 is formed between electret layer 209 and the upper surface of diaphragm 205 and a lower air gap 303 is formed between electret layer 211 and the lower surface of diaphragm 205. It should be understood that it is not necessary for the aperture(s) 213 in the lower backplate 207 to be aligned with the acoustic aperture(s) 201 in the upper backplate 203 as shown.

In ECM 200, the acoustic sound pressure wave radiates off of diaphragm 205, passes through lower air gap 303 and aperture(s) 213, and enters the acoustical air cavity 215 formed between lower backplate 207 and the PCB 117 containing IC 119. Conductive spring washer 217 holds lower backplate 207 firmly against lower spacer 219 when ferrule 101 is crimped against PCB 117. The tension ring assembly visible in both FIGS. 2 and 3 is comprised of a stiff non-conductive material body 221, preferably fabricated from ceramic, with an upper metallized surface 223, a lower metallized surface 224, and a narrow conductive surface/pathway 225 that electrically connects surfaces 223 and 224. As discussed in detail below, diaphragm 205 may be conductive throughout or utilize a metalized coating on the diaphragm surface that is adjacent to surface 223. The primary purpose of tension ring 221 is to maintain the tension on diaphragm 205 after the diaphragm has been bonded, under tension, using a conductive adhesive to tension ring metallization 223. Tension ring 221 must be non-conductive to prevent shorting between lower backplate 207 and the inside of the metallic ferrule 101, and to minimize stray capacitance between the tension ring metallized surfaces and lower backplate 207.

As shown and described above, ECM 200 contains two capacitive transduction cells sharing a common diaphragm 205, with each transduction cell bounded by the diaphragm electrode and either the upper backplate 203 or the lower backplate 207. This configuration is referred to herein as a dual backplate structure, although it may also be referred to as a push-pull structure.

In ECM 200, lower backplate 207 is positioned within tension ring 221, i.e., the outside diameter (OD) of backplate 207 is smaller than the inside diameter (ID) of tension ring 221. In this configuration, in order to avoid increasing the outside diameter of ferrule 101 or decreasing the vibrating (i.e., active) portion of diaphragm 205, tension ring 221 employs very thin walls, preferably on the order of 0.3 millimeters thick. It will be appreciated that reducing the area of the active portion of diaphragm 205, and thus the active capacitance, Cₐ, would tend to defeat the advantage of the dual cell approach. Accordingly, in at least one preferred embodiment tension ring 221 is made from a very strong and non-conducting material such as an aluminum oxide ceramic with at least 92% Al₂O₃. Note that the active portion of diaphragm 205 is defined by the ID of the annular spacers 115 (i.e., the upper spacer) and 219 (i.e., the lower spacer).

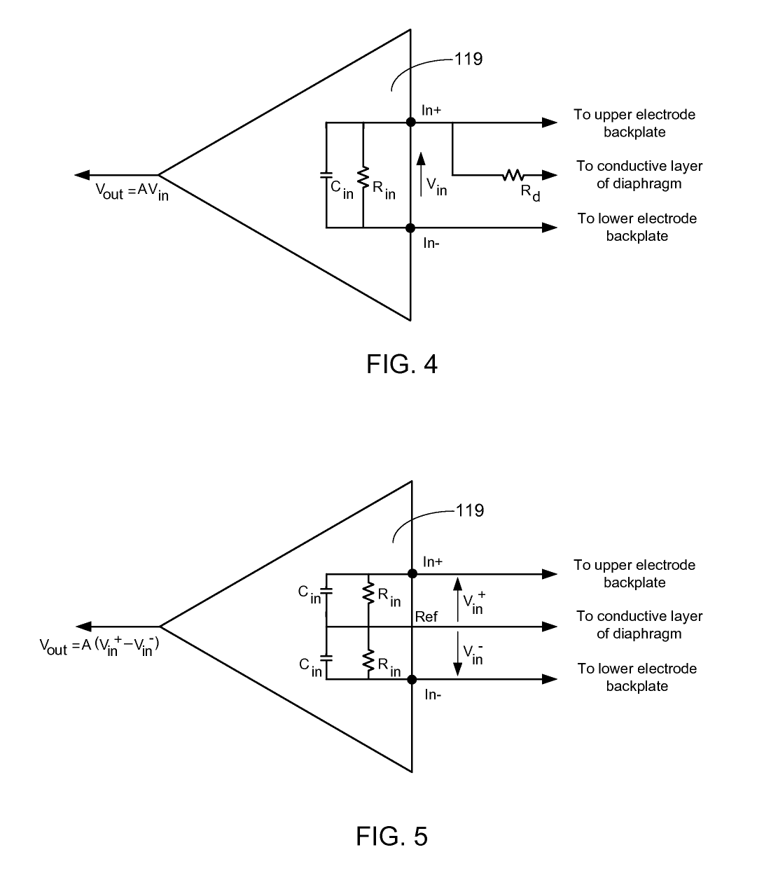

The upper and lower cells of ECM 200, i.e., the capacitive systems above and below diaphragm 205, are configured in an electrical series push-pull configuration. This configuration provides twice the open circuit signal voltage, E_{oc}, and half the active and stray capacitances, Cₐ and Cₛ, of a single cell as used in a conventional ECM. This series push-pull configuration is preferably coupled to IC 119 as shown in either FIG. 4 or FIG. 5. In these configurations, IC 119 is a voltage-type operational amplifier (op-amp) with a very low input capacitance, Cᵢₙ, and very high input impedance, Rᵢₙ, resulting in an approximate 6 dB voltage signal increase at the input of IC 119. In addition, because a dual backplate structure is force balanced in an electrostatic sense at its neutral position, whereas a single-sided prior art electret design is not, the inventive microphone can be electrostatically biased with a well-defined higher and stable electret charge in each of the two electret fluoropolymer layers 209 and 211. In this electrical series preferred embodiment where the electret layers 209 and 211 are attached to backplates 203 and 207, respectively, and assuming that the diaphragm is conductive throughout, the trapped electret surface charge is preferably equal and negative in magnitude in both layers abutting the respective air gaps 301 and 303 (note that if the diaphragm includes a metalized polymer layer, then the optimal surface charge of the two electrets will be somewhat different in magnitude). Alternately, the trapped electret surface charge may be positive in both layers. Hence, due to an at least 30% higher stable electret charge, the IC input is further enhanced by 2 or more dB (depending on design parameters) on top of the 6 dB increase over the prior art single-sided electret microphone designs mentioned above.

In the configuration illustrated in FIG. 4, In⁻ of the single-ended IC 119 voltage-type amplifier receives its signal via PCB 117, conductive spring washer 217 and lower backplate 207. In⁺ of IC 119 receives its signal from PCB 117, ferrule 101 and upper backplate 203. In is also connected via PCB 117 and metallized pathways 223-225 to diaphragm 205. Alternately, In⁺ may be connected to diaphragm 205 via PCB 117, ferrule 101, and a direct connection or connection via means such as a conductive epoxy, small contact spring, or the like, between ferrule 101 and metalized pathways 223-225. Preferably diaphragm 205 is made of a polymeric base film resin (e.g., 2 micrometers of polyphenylene sulfide (PPS) or polyethylene terephthalate (PET) is preferred) which is bulk alloyed with a conductive additive (e.g., an inherently dissipative polymer (IDP) anti-static compound) distributed throughout its thickness. In an exemplary embodiment, the surface resistivity of such a diaphragm is between 5.0E10 and 1.0E13 ohms/square, and more preferably between 1.0E11 and 5.0E11 ohms/square, and still more preferably set at approximately 2.0E11 ohms/square. In an alternate preferred embodiment, diaphragm 205 is made from a non-conductive base film that is surface-metallized with a very thin layer or coating so as to yield the same surface resistivity as noted above. Regardless of the method used to fabricate diaphragm 205, the conductivity is made so low that it creates a very high, but finite, (distributed) total radial resistance, R_{d}, as shown in FIG. 4. FIG. 4 illustrates the preferred electrical interconnects and the voltage-type op-amp IC 119 that is best suited for an electrical series push-pull configuration.

It is important to insure that the electrostatic biasing of the electrical series cells provides fixed electric fields in the air gaps. Based on the configuration shown in FIG. 4, mathematically integrating the product of R_{d} with the radially distributed capacitance of the upper cell (including air gap 301) having a capacitance, C, equal to Cₐ+Cₛ, yields an R_{d}C time constant for charge up/decay for that cell. Assuming that both cells are identical, in at least one embodiment, Cₐ is equal to 1.9 pF, Cₛ is equal to 1.6 pF, Cᵢₙ is equal to 0.3 pF (i.e., much less than C), Rᵢₙ is equal to 10 gigaohms, and R_{d} is equal to 32 gigaohms. The resultant time constant, R_{d} C, of 112 milliseconds is designed to be much larger than half of the period of the lowest audio frequency, F_{c}, which in at least one instance for F_{c} equal to 20 Hz, is 25 milliseconds. It will be appreciated that R_{d} C will be somewhat larger for the lower cell (i.e., air gap 303) since in that instance Rᵢₙ adds to R_{d}. Additionally, the dc charge up/decay of diaphragm 205 from both cells is charge additive although not at the same rate. Note that Cᵢₙ has been ignored as it is small compared to C in the time constant estimate above. Accordingly for this set of parameters and at dc and well below F_{c}, positive (i.e., induced) charge can build up on diaphragm 205 to compliment the trapped negative electret charge on 209 and 211, thus creating the required biasing and fixed electric fields in the upper and lower air gaps 301 and 303, respectively. Critically, as required above F_{c}, that biasing induced electrostatic charge built-up on diaphragm 205 cannot discharge or leak-off the diaphragm during ac (i.e., audio signal) motions above F_{c}. Such a discharge would result in a disadvantageous input-output non-linearity, and thus signal distortion. As a result of the advantageous R_{d} design, the ac signal arriving at inputs In⁻ and In⁺ of IC 119 comes solely from upper backplate 203 and lower backplate 207, and not diaphragm 205.

In the alternate configuration illustrated in FIG. 5, a differential voltage-type op-amp is used for IC 119 rather than the single-ended voltage-type amplifier shown in FIG. 4. Vₒᵤₜ is substantially the same in the configurations illustrated in FIGS. 4 and 5, but by using the differential amplifier the diaphragm's distributed resistance, R_{d}, can be replaced with two input resistors, Rᵢₙ, where Rᵢₙ would take on the preferred numerical value of R_{d} given above while Cᵢₙ represents the parasitic input capacitance of the IC. Note that this was not possible in the configuration shown in FIG. 4 since at R_{d} equal to 0, the upper cell would be a short circuit resulting in a large signal non-linearity as the diaphragm current leaked-off with motion of the diaphragm. Note that in the configuration of FIG. 5, diaphragm 205 does not need to be fabricated to yield the distributed resistance, R_{d}, as specified for FIG. 4.

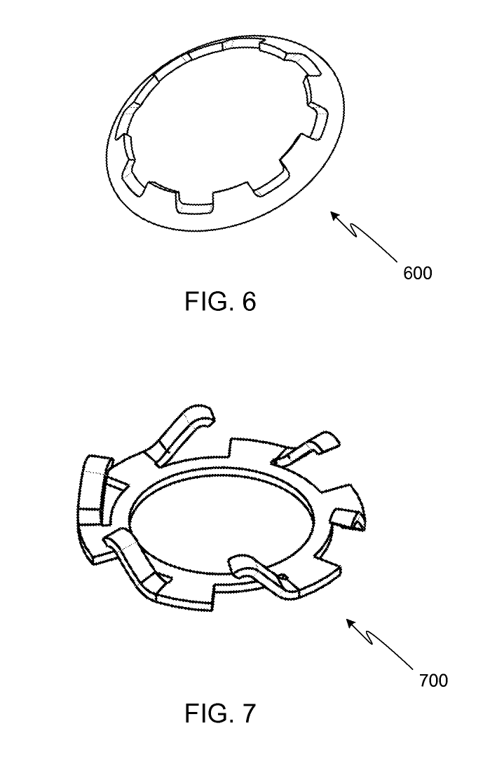

While the present invention is not limited to a specific design for spring washer 217, FIGS. 6 and 7 illustrate two exemplary designs 600 and 700, respectively, applicable to washer 217 of ECM 200. Regardless of the design of washer 217, it is intended to apply a static compressive force on lower backplate 207, thus insuring the proper spacing for lower air gap 303. While the force exerted by washer 217 is significant, by necessity it is considerably lower than the axial crimp force of ferrule 101. Additionally spring washer 217 is designed and assembled so as to create the lowest mechanical bending moment arms on both PCB 117 and lower backplate 207. In at least one preferred embodiment, washer 217 is comprised of a Belleville-type spring washer (e.g., washer 600) with a thickness of 0.1 millimeters that provides 30 N of compressive force on lower backplate 207 when compressed to the desired working height of 0.40 millimeters, the distance between PCB 117 and backplate 207. At the desired working height, this washer provides a spring constant of approximately 1.8E5 N/m. Washer 700 illustrates an alternate preferred design. It will be appreciated that other designs (e.g., a wave type spring washer) may be used for washer 217.

The dual backplate structures disclosed herein are electrostatically force balanced in their dc or quiescent state (i.e., the net electrostatic force on the diaphragm is zero). This is quite different from a conventional single-sided electret microphone in which the electrostatic force on the diaphragm, which is proportional to the air gap's electric field squared, is balanced at dc by the restoring tension force in the diaphragm. In its dynamic mode, the diaphragm of such a conventional microphone is influenced by the sound pressure, tension or mechanical stiffness, diaphragm inertial force, electrostatic force, acoustical thin air-film damping in air gap 131, and the acoustical stiffness that is inversely proportional to the air volume in the acoustic air cavity 133. In the dynamic mode of the dual backplate structures disclosed herein, the same forces generally come into play, but the tension and inertial diaphragm restoring forces are shared between cells.

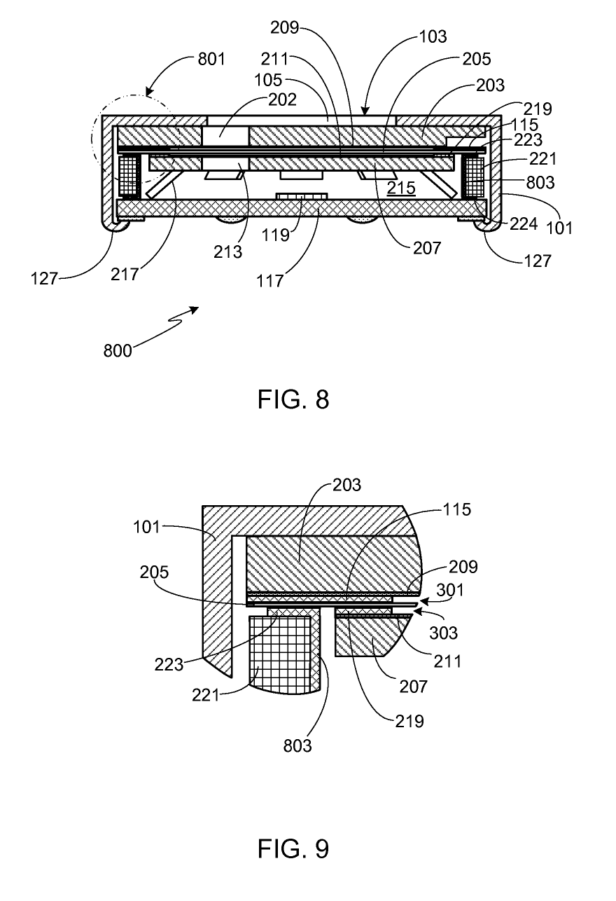

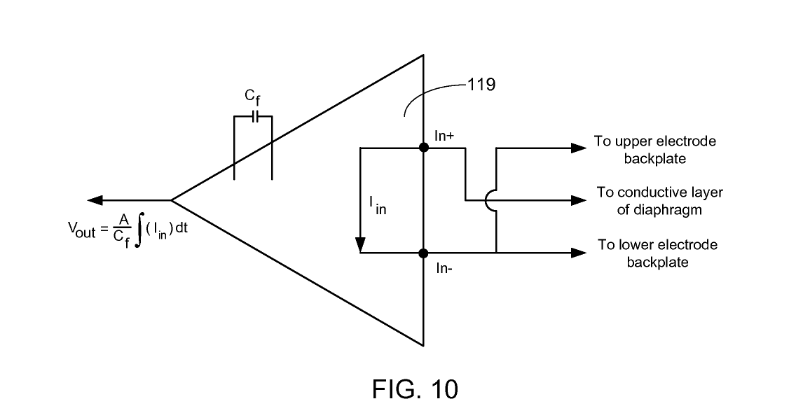

FIG. 8 provides a cross-sectional view of an alternate preferred embodiment of a dual backplate ECM 800 in accordance with the invention. FIG. 9 provides a detailed cross-sectional view of portion 801 of ECM 800. In ECM 800 the two capacitive transduction cells of the structure are intended to be electrically connected in parallel to the input of op-amp IC 119, rather than in series as in the prior configuration. As a result, the combined cell open circuit voltage, E_{oc}, is unchanged from that of each cell. Accordingly, the combined E_{oc} will be enhanced by only the 2 or more dB discussed earlier due to the enhanced electrostatic balance of the push-pull configuration. However, the combined cells will now have twice the capacitance, i.e., 2*(Cₐ+Cₛ), of a conventional single cell microphone. Therefore the signal current output of the combined cells, here proportional to 2*(Cₐ+Cₛ), will provide a 6 dB enhancement in output signal level from a charge-type amplifier IC 119. FIG. 10 illustrates the preferred electrical connections between ECM 800 and IC 119.

To construct the preferred embodiment shown in FIGS. 8 and 9, the Thevenin signal current for each cell must be directed instantaneously into, or out of, diaphragm 205 (i.e., in phase). Therefore unlike the embodiment illustrated in FIGS. 2 and 3, in the present embodiment the dc electric fields in air gaps 301 and 303 must be in the same direction. To achieve this effect, electret layer 211 of lower backplate 207 is negatively charged while electret layer 209 of upper backplate 203 is positively charged. Again, if the upper cell alone contains the metalized diaphragm's dielectric thickness, the magnitude of the two charge levels will be somewhat different to insure dc electrostatic force balance. Alternately, electrostatic biasing can be achieved by other means, such as removing the positively charged fluoropolymer layer 209 from the upper backplate 203 and making diaphragm 205 from fluoropolymer with a metallization on the diaphragm's lower surface and negatively charged on its upper surface abutting the upper air gap 301. Again, the two charge magnitudes will have to be somewhat different to insure dc electrostatic force balance.

As shown in FIG. 10, for the embodiment shown in FIGS. 8 and 9 driven into a charge-type amplifier, there is no resistive element, nor RC time constant, designed into diaphragm 205 or supplied on IC 119. In this embodiment, In⁺ of op-amp IC 119 receives its signal from the bulk conductive or lower metallized layer of diaphragm 205 via PCB 117 and the metallized trace on tension ring 221. Note that the metallized trace on tension ring 221 includes upper surface metallization 223, lower surface metallization 224 and a narrow pathway metallization 803 that couples the upper metallization to the lower metallization. Preferably pathway metallization 803 is located between the outer and inner surfaces of tension ring 221, for example in a narrow notch on the inner surface of ring 221, thus preventing shorts and minimizing stray capacitance between the trace and either lower backplate 207 or ferrule 101. In⁻ of op-amp IC 119 is connected to the upper backplate 203 via ferrule 101 and PCB 117, and to the lower backplate 207 via conductive spring washer 217 and PCB 117.

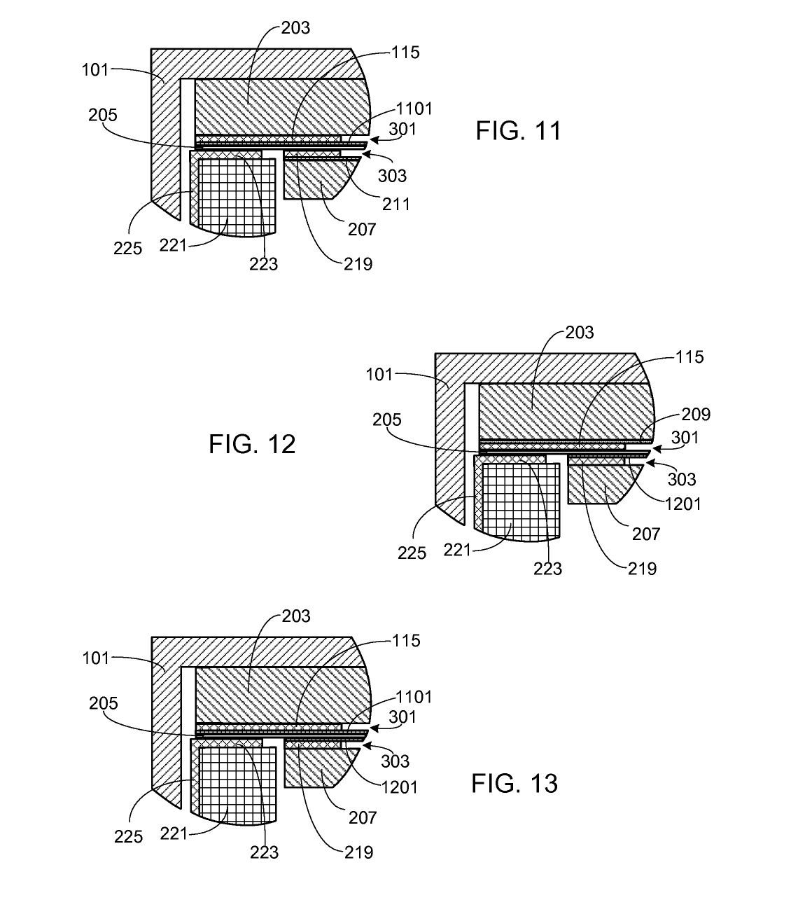

In the embodiments described relative to FIGS. 2, 3, 8 and 9, the electret layers, e.g., electret layers 209 and 211, are attached to respective backplate electrodes 203 and 207. It should be understood, however, that the electret layer(s) may also be attached to the diaphragm such that the electret layer(s) is still interposed between the conductive layer of the diaphragm and the conductive backplate. For example, FIG. 11 provides a similar detailed view to that shown in FIG. 3 except that upper backplate 203 does not include an electret layer. In this embodiment an electret layer 1101 is attached (e.g., via bonding or deposition) to diaphragm 205, electret layer 1101 being interposed between the conductive layer of diaphragm 205 and upper backplate 203. For example, if electret layer 211 is negatively charged, then electret layer 1101 is positively charged for the cells in electrical series configuration of FIG. 3. Similarly, FIG. 12 illustrates the replacement of electret layer 211 on lower backplate 207 of FIG. 3 with an electret layer 1201 attached (e.g., via bonding or deposition) to diaphragm 205, where electret layer 1201 is interposed between the conductive layer of diaphragm 205 and lower backplate 207. Similarly, FIG. 13 illustrates the replacement of electret layers 209 and 211 in FIG. 3 with electret layer 1101 and 1201, each of which is interposed between the conductive layer on the diaphragm and respective backplates 203 and 207, and in this case both charges can be of the same polarity (preferably negative).

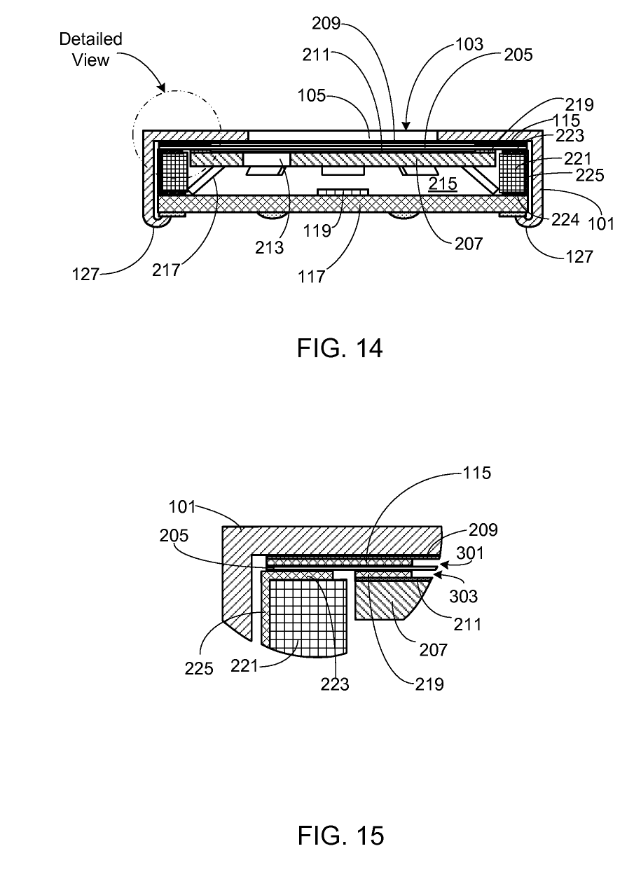

The dual backplate ECM configurations described above utilize a pair of conductive backplates 203 and 207. Although this approach is generally preferred, the inventors have found that upper backplate 203 may be eliminated if desired. In such a configuration, the inner surface of ferrule 101, adjacent to the diaphragm, replaces backplate 203. For example, FIG. 14 illustrates an ECM similar to the configuration shown in FIG. 2, except electret charged fluoropolymer layer 209 is applied directly to the inner surface of the upper ferrule surface. FIG. 15 provides a detailed cross-sectional view of this configuration, similar to that provided by FIG. 3. It should be understood that any of the previously disclosed embodiments can be similarly modified by eliminating backplate 203.

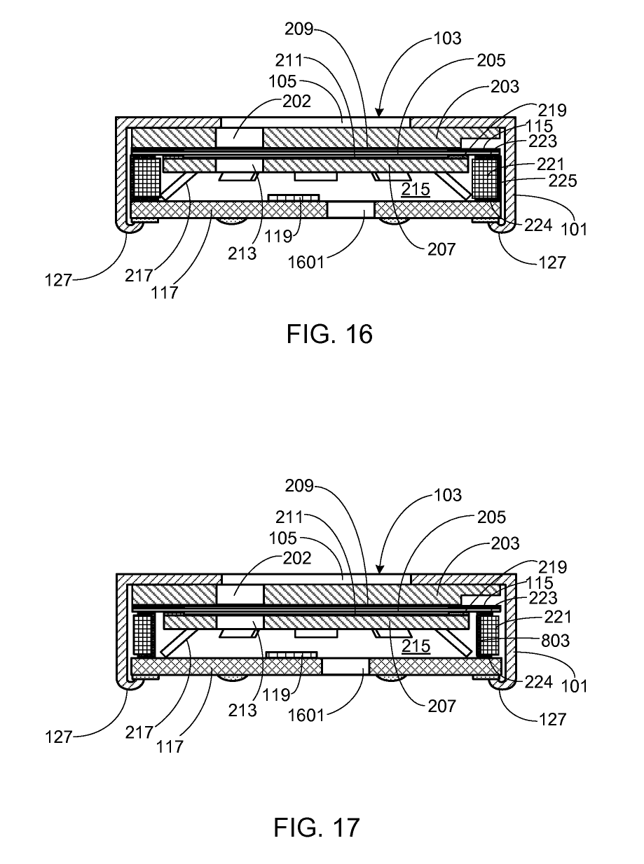

While the dual backplate microphone of the invention has been described relative to an omnidirectional type ECM, it should be understood that the disclosed designs are equally applicable to a gradient type ECM, thus providing advantageous directional or noise-canceling pickup performance for certain applications. In order to modify the previously disclosed designs to yield a gradient type ECM, a second sound port is added through PCB 117. For example, FIGS. 16 and 17 illustrate embodiments similar to those shown in FIGS. 2 and 8, respectively, in which a second sound port 1601 has been added, thus allowing the sound signal to be acoustically subtracted across the diaphragm.

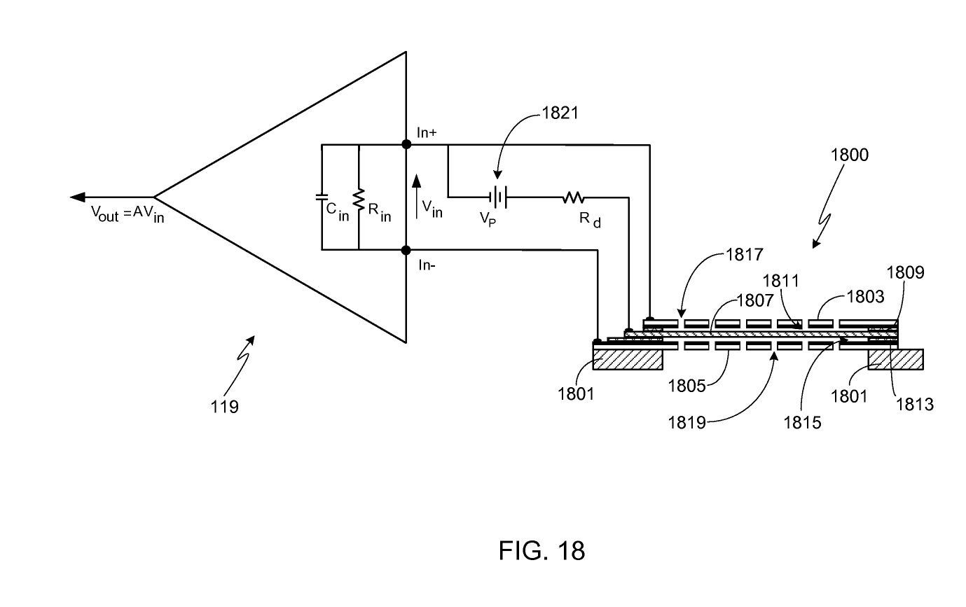

FIG. 18 illustrates a configuration similar to that shown relative to FIGS. 2 and 4 as applied to a microelectromechanical system (MEMS) type condenser microphone 1800. Note that FIG. 18 shows both the device, i.e., MEMS 1800, and its connection to op-amp IC 119. Substrate 1801 supports the layered structure of MEMS transducer die 1800, MEMS transducer 1800 including an upper micromachined backplate 1803, a lower micromachined backplate 1805 and a diaphragm 1807 sandwiched between the two backplates. Diaphragm 1807 includes a conductive layer. An upper spacer 1809 creates an upper air gap 1811 between diaphragm 1807 and upper backplate 1803. Similarly, a lower spacer 1813 creates a lower air gap 1815 between diaphragm 1807 and lower backplate 1805. Similar to the previously described ECM embodiments, in MEMS transducer 1800 air gaps 1811 and 1815 vary in thickness as diaphragm 1807 vibrates under the action of sound pressure thereby forming the varying portion of the two transduction cells. Note that the sound pressure may enter the system of dual cells either through the array of apertures 1817 in upper backplate 1803 or the array of apertures 1819 in lower backplate 1805, depending on the MEMS transducer die's placement in the MEMS microphone's housing or mechanoacoustic package (not shown). As used herein, a mechanoacoustic package collects the sound from the end-user's device (e.g., telephone handset or hand-held device) while housing the MEMS transducer die (e.g., die 1800) and the signal processing electronics (e.g., op-amp IC 119). It will be appreciated that in a typical embodiment, op-amp IC 119 and transducer die 1800 are incorporated on separate die, although if desired the two may be co-located on the same die.

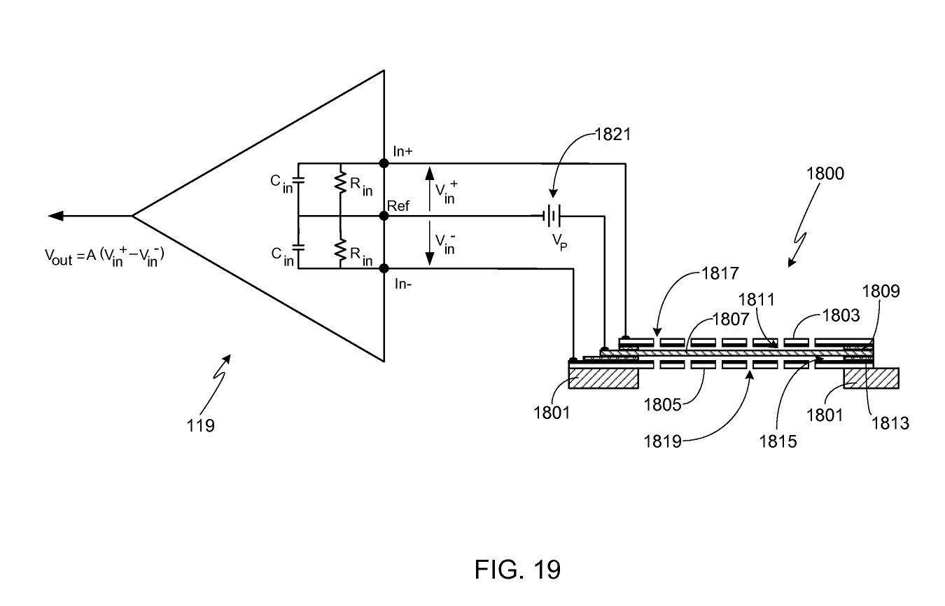

In the MEMS embodiment of FIG. 18, as in the ECM embodiment shown in FIG. 4, the dual cells are in electrical series and are coupled to a single ended voltage type op-amp IC 119. Since it is uncommon to employ an internally trapped electret charge type biasing in a MEMS structure such as that of FIG. 18, preferably external dc voltage polarization via a charge pump 1821 of voltage V_{P} is incorporated on the IC die. In this configuration the sign of V_{P} will only change the phase of the audio signal output by 180 degrees. This results in polarizing electric fields in the two air gaps 1811 and 1815 which are in the opposite direction as desired for this electrical series cell configuration. As described above relative to FIG. 4, R_{d} must be large enough so that the resulting upper cell's time constant, R_{d} C, is around 112 milliseconds and much larger than half of the period of the lowest audio frequency, F_{c}, which in at least one instance for F_{c} equal to 20 Hz, is 25 milliseconds. Then, as required above F_{c}, the polarizing induced electrostatic charge built up on diaphragm 1807 and upper and lower backplates 1803 and 1805, respectfully, cannot re-distribute (i.e., leak off) during ac motions (i.e., audio signals above F_{c}) of the diaphragm. Preferably the value of R_{d} is selected such that the ac signal arriving at In⁻ and In⁺ of IC 119 comes solely from upper backplate 1103 and lower backplate 1805, and not from diaphragm 1807. Note that the R_{d} resistance can be built into diaphragm 1807, or the backplates, or the conducting paths of MEMS transducer die 1800. Alternately, it can be incorporated on op-amp IC 119 as incorporated in FIG. 19.

FIG. 19 illustrates an alternate embodiment of the system shown in FIG. 18 in which the dual cells of the MEMS transducer die 1800 are connected in electrical series to a differential type voltage op-amp IC 119 and as such does not include resistance R_{d} formed within the MEMS die. Rᵢₙ of IC 119 is designed to take on the preferred numerical value of R_{d} given above. Note that the embodiment of FIG. 19 is the MEMS equivalent of the previously described ECM microphone using the IC configuration shown in FIG. 5, with the addition of charge pump 1821 instead of trapped electrical charges.

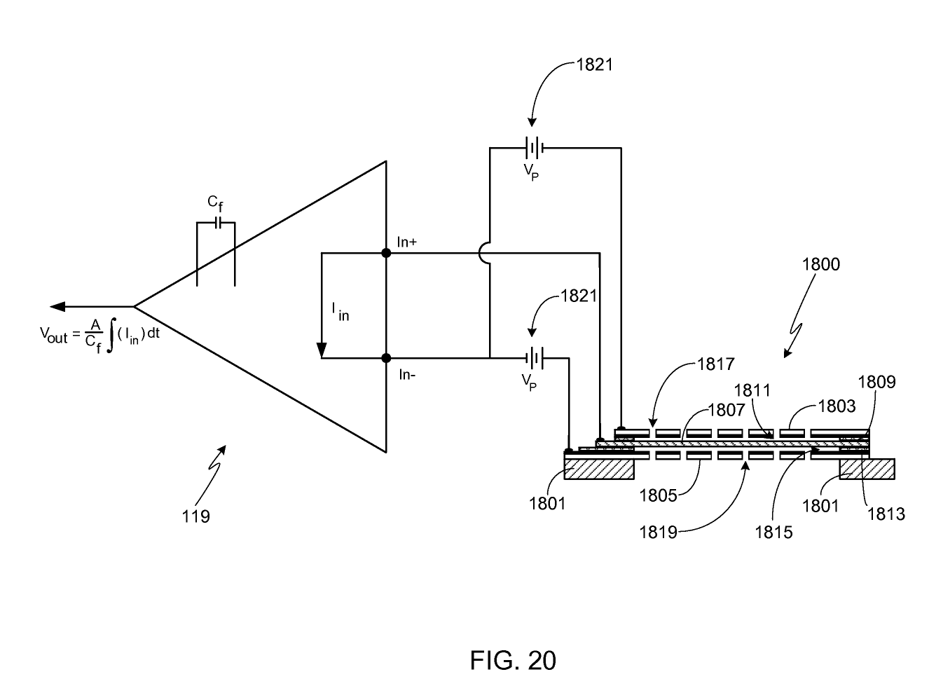

FIG. 20 illustrates another alternate embodiment of the system shown in FIG. 18 in which the dual cells of the MEMS transducer die 1800 are connected in electrical parallel to a charge type op-amp IC 119 such as that shown in FIG. 10. External dc voltage polarization via the two charge pumps 1821, likely incorporated on the IC 119 die, is advantageously employed to supply a polarization voltage of opposite polarity to each of the two backplates 1803 and 1805. As a result of this configuration, polarizing electric fields in the two air gaps 1811 and 1815 are the same in direction as desired for this parallel cell configuration.

It should be understood that the MEMS embodiments shown in FIGS. 18-20 could alternately use internal electret trapped charge to dc bias the dual cells as opposed to using an externally applied dc polarizing voltage from one or more charge pumps 1821. Furthermore, while the electrical series dual cell type ECM and MEMS embodiments described and shown above are preferably matched to voltage type op-amp IC's, and the electrical parallel dual cell type ECM and MEMS embodiments described and shown above are preferably matched to charge type op-amp IC's, any of the dual cell type ECM and MEMS embodiments described above could be matched with either of these op-amp types, or to a hybrid voltage-charge type op-amp if desired.

It should be understood that identical element symbols used on multiple figures refer to the same component, or components of equal functionality. Additionally, the accompanying figures are only meant to illustrate, not limit, the scope of the invention and should not be considered to be to scale.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention which is set forth in the following claims.

What is claimed is:

1. An electret condenser microphone (ECM), comprising:
an electrically conductive casing, wherein said electrically conductive casing has a first end portion and a second end portion, wherein said first end portion is comprised of at least one acoustic aperture of a first type;
a circuit board disposed within said electrically conductive casing and closing an opening at said second end portion of said electrically conductive casing;
a first backplate disposed within said electrically conductive casing, wherein a first surface of said first backplate is adjacent to an inner surface of said first end portion of said electrically conductive casing, wherein said first backplate is comprised of at least one acoustic aperture of a second type;
a second backplate disposed within said electrically conductive casing, wherein a first surface of said second backplate is directed towards said circuit board disposed within said electrically conductive casing, wherein said second backplate is comprised of at least one acoustic aperture of a third type;
a diaphragm interposed between a second surface of said first backplate and a second surface of said second backplate, wherein said diaphragm is further comprised of at least one electrically conductive layer;
at least one first spacer separating said second surface of said first backplate from said diaphragm, wherein said at least one first spacer creates a first air gap between said first backplate and said diaphragm;
a first electret layer interposed between said second surface of said first backplate and said at least one electrically conductive layer of said diaphragm;
at least one second spacer separating said second surface of said second backplate from said diaphragm, wherein said at least one second spacer creates a second air gap between said second backplate and said diaphragm;
a second electret layer interposed between said second surface of said second backplate and said at least one electrically conductive layer of said diaphragm;
an electrically non-conductive tensioning ring disposed within said electrically conductive casing, wherein said second backplate is disposed within said electrically non-conductive tensioning ring, and wherein said electrically non-conductive tensioning ring is interposed between an outer surface of said second backplate and said electrically conductive casing; and
an operational amplifier (op-amp) integrated circuit (IC) electrically coupled to said first backplate, said second backplate and said at least one electrically conductive layer of said diaphragm, wherein said op-amp IC provides signal processing for said ECM.

2. The ECM of claim 1, wherein said first electret layer is comprised of a first electret charged fluoropolymer layer, and wherein said second electret layer is comprised of a second electret charged fluoropolymer layer.

3. The ECM of claim 1, wherein said first electret layer is attached to said first backplate.

4. The ECM of claim 1, wherein said first electret layer is attached to said diaphragm.

5. The ECM of claim 1, wherein said second electret layer is attached to said second backplate.

6. The ECM of claim 1, wherein said second electret layer is attached to said diaphragm.

7. The ECM of claim 1, wherein said electrically non-conductive tensioning ring is comprised of a ceramic material.

8. The ECM of claim 1, further comprising an electrically conductive spring washer disposed within said electrically conductive casing and interposed between said first surface of said second backplate and said circuit board, wherein said electrically conductive spring washer holds said second backplate in place.

9. The ECM of claim 8, wherein said op-amp IC is a single-ended voltage-type op-amp IC, wherein a first input of said single-ended voltage-type op-amp IC is electrically connected to said second backplate via said circuit board and said electrically conductive spring washer, and wherein a second input of said single-ended voltage-type op-amp IC is electrically connected to said first backplate via said circuit board and said electrically conductive casing.

10. The ECM of claim 9, further comprising a plurality of metallized surfaces disposed on said electrically non-conductive tensioning ring, wherein said second input of said single-ended voltage-type op-amp IC is electrically connected to said at least one electrically conductive layer of said diaphragm via said circuit board and said plurality of metallized surfaces.

11. The ECM of claim 9, further comprising a plurality of metallized surfaces disposed on said electrically non-conductive tensioning ring, wherein said second input of said single-ended voltage-type op-amp IC is electrically connected to said at least one electrically conductive layer of said diaphragm via said circuit board and said electrically conductive casing and said plurality of metallized surfaces.

12. The ECM of claim 10, wherein said diaphragm is comprised of a polymeric base film resin bulk alloyed with a conductive additive.

13. The ECM of claim 12, wherein said diaphragm has a surface resistivity of between 5.0E10 and 1.0E13 ohms/square.

14. The ECM of claim 12, wherein said diaphragm has a surface resistivity of between 1.0E11 and 5.0E11 ohms/square.

15. The ECM of claim 10, wherein said diaphragm is comprised of a non-conductive base film, wherein a surface of said non-conductive base film is further comprised of a surface metallization.

16. The ECM of claim 15, wherein said diaphragm has a surface resistivity of between 5.0E10 and 1.0E13 ohms/square.

17. The ECM of claim 15, wherein said diaphragm has a surface resistivity of between 1.0E11 and 5.0E11 ohms/square.

18. The ECM of claim 8, wherein said op-amp IC is a differential voltage-type op-amp IC, wherein a first input of said differential voltage-type op-amp IC is electrically connected to said second backplate via said circuit board and said electrically conductive spring washer, wherein a second input of said differential voltage-type op-amp IC is electrically connected to said first backplate via said circuit board and said electrically conductive casing, and wherein a reference input of said differential voltage-type op-amp IC is electrically connected to said at least one electrically conductive layer of said diaphragm.

19. The ECM of claim 18, further comprising a plurality of metallized surfaces disposed on said electrically non-conductive tensioning ring, wherein said reference input of said differential voltage-type op-amp IC is electrically connected to said at least one electrically conductive layer of said diaphragm via said circuit board and said plurality of metallized surfaces.

20. The ECM of claim 18, further comprising a plurality of metallized surfaces disposed on said electrically non-conductive tensioning ring, wherein said reference input of said differential voltage-type op-amp IC is electrically connected to said at least one electrically conductive layer of said diaphragm via said circuit board and said electrically conductive casing and said plurality of metallized surfaces.

21. The ECM of claim 8, further comprising a plurality of metallized surfaces disposed on said electrically non-conductive tensioning ring, wherein said op-amp IC is a charge-type op-amp IC, wherein said first input of said charge-type op-amp IC is electrically connected to said diaphragm via said circuit board and said plurality of metallized surfaces, wherein a second input of said charge-type op-amp IC is electrically connected to said first backplate via said circuit board and said electrically conductive casing and to said second backplate via said circuit board and said electrically conductive spring washer.

22. The ECM of claim 8, further comprising a plurality of metallized surfaces disposed on said electrically non-conductive tensioning ring, wherein said op-amp IC is a charge-type op-amp IC, wherein said first input of said charge-type op-amp IC is electrically connected to said diaphragm via said circuit board and said electrically conductive casing and said plurality of metallized surfaces, wherein a second input of said charge-type op-amp IC is electrically connected to said first backplate via said circuit board and said electrically conductive casing and to said second backplate via said circuit board and said electrically conductive spring washer.

23. The ECM of claim 1, wherein said circuit board includes at least one sound port.

24. The ECM of claim 1, wherein said first backplate and said electrically conductive casing are fabricated as a single electrically conductive component.

25. A microelectromechanical system (MEMS) type condenser microphone, comprising:
a first micromachined backplate, wherein said first micromachined backplate is comprised of at least one layer of a first conductive material and at least one acoustic aperture;
a second micromachined backplate, wherein said second micromachined backplate is comprised of at least one layer of a second conductive material and at least one acoustic aperture;
a diaphragm interposed between said first and second micromachined backplates, wherein said diaphragm is further comprised of at least one electrically conductive layer;
at least one first spacer separating said first micromachined backplate from said diaphragm, wherein said at least one first spacer creates a first air gap between said first micromachined backplate and said diaphragm;
at least one second spacer separating said second micromachined backplate from said diaphragm, wherein said at least one second spacer creates a second air gap between said second micromachined backplate and said diaphragm; and
an operational amplifier (op-amp) integrated circuit (IC) electrically coupled to said at least one layer of said first conductive material of said first micromachined backplate, said at least one layer of said second conductive material of said second micromachined backplate and said at least one electrically conductive layer of said diaphragm, wherein said op-amp IC provides signal processing for said MEMS type microphone.

26. The MEMS type microphone of claim 25, further comprising a charge pump coupled to said diaphragm, wherein said op-amp IC is a single-ended voltage-type op-amp IC, wherein a first input of said single-ended voltage-type op-amp IC is electrically connected to said first micromachined backplate, wherein a second input of said single-ended voltage-type op-amp IC is electrically connected to said second micromachined backplate, and wherein said first input of said single-ended voltage-type op-amp IC is electrically connected to said at least one electrically conductive layer of said diaphragm via said charge pump.

27. The MEMS type microphone of claim 26, further comprising a source of resistance, wherein said source of resistance is placed in series with said charge pump.

28. The MEMS type microphone of claim 27, wherein said source of resistance is said diaphragm, and wherein said diaphragm has a surface resistivity of between 5.0E10 and 1.0E13 ohms/square.

29. The MEMS type microphone of claim 25, further comprising a charge pump coupled to said diaphragm, wherein said op-amp IC is a differential voltage-type op-amp IC, wherein a first input of said differential voltage-type op-amp IC is electrically connected to said first micromachined backplate, wherein a second input of said differential voltage-type op-amp IC is electrically connected to said second micromachined backplate, and wherein a reference input of said differential voltage-type op-amp IC is electrically connected to said at least one electrically conductive layer of said diaphragm via said charge pump.

30. The MEMS type microphone of claim 25, further comprising a first charge pump of a first polarity and a second charge pump of a second polarity, wherein said second polarity is opposite of said first polarity, wherein said op-amp IC is a charge-type op-amp IC, wherein said first input of said charge-type op-amp IC is electrically connected to said at least one electrically conductive layer of said diaphragm, wherein a second input of said charge-type op-amp IC is electrically connected to said first micromachined backplate via said first charge pump and to said second micromachined backplate via said second charge pump.
